(19) United States
(12) Patent Application Publication
(10) Pub. No.: US 2017/0356688 A1
(43) Pub. Date: Dec. 14, 2017

(54) METHOD AND FURNACE FOR CONTINUOUSLY HEATING A STRIP WORKPIECE

(71) Applicant: Siempelkamp Maschinen - und Anlagenbau GmbH, Krefeld (DE)

(72) Inventor: Klaus Gartz, Viersen (DE)

(21) Appl. No.: 15/614,915

(22) Filed: Jun. 6, 2017

(30) Foreign Application Priority Data
Jun. 13, 2016 (DE) 102016110808.1

(51) Int. Cl. F27B 9/36; F27D 11/12; F27B 9/24; F26B 3/28

(52) U.S. Cl. CPC F27B 9/36; F27B 9/24; F27D 11/12; F26B 3/28

(57) ABSTRACT

A method of continuously heating a moving strip workpiece entails the steps of passing the strip workpiece in a horizontal travel direction through a tunnel furnace with a tunnel housing of oval cross section, providing the oval cross section of greater horizontal width than vertical height, and irradiating the workpiece with microwave radiation in the tunnel housing.

### FIELD OF THE INVENTION

The present invention relates to the heating of a strip workpiece. More particularly this invention concerns a method and furnace for heating a continuously moving strip workpiece.

### BACKGROUND OF THE INVENTION

Typically a continuous strip workpiece is passed through a tunnel furnace and irradiated, for instance with microwaves, to heat it. The strip workpiece to be heated is here a pressed mat of chips and/or fibers for the manufacture of wood-based panels or the like, so that the invention preferably relates to a method of preheating such a pressed mat. In principle, however, the heating and/or drying of other strip workpieces is also included.

A pressed mat for the manufacture of wood-based panels generally consists of shavings or fibers, particularly wood shavings or wood fibers and preferably glued wood shavings or wood fibers that are generally scattered onto a belt conveyor or the like to form a pressed mat. A continuous pressed mat (and consequently a pressed mat strip) is generally produced as a result that is subsequently pressed in a press, for example a continuously operating dual-belt press, under application of pressure and heat to form a strip from that can be cut into panels. In order to optimize the pressing process, preheating of the material to be pressed or pressed mat is often performed. Preheating can be performed in a preheating press, for example.

The invention concerns the preheating of such a strip workpiece, for example a pressed mat, with the aid of microwave radiation. According to the invention, “microwave radiation” refers to electromagnetic radiation in a frequency range from 100 MHZ to 300 GHz, preferably 300 MHZ to 100 GHz. The microwave radiation is generally generated using one or more microwave generators, for example magnetrons that are either fastened directly on the housing of the tunnel furnace or can also be arranged separately, with the microwave generators (for example magnetrons) then being connected to the housing via waveguides or the like or directed into the interior of the housing.

A method and a tunnel furnace for the continuous preheating of a pressed mat of the above-described type is known, for example, from U.S. Pat. No. 8,540,924. Microwaves in a frequency range from 2400 to 2500 MHZ are used to heat the pressed mat, the microwaves being generated for each side of the pressed surface from 20 to 300 microwave generators with magnetrons each having an output of 3 to 50 kW. The inlet and output of the tunnel furnace are adjustable with respect to height and/or width. Movable absorption elements such as absorbent stones and/or water containers, for example, can be provided to change the inlet or output.

U.S. Pat. No. 5,756,975 describes a device and a method of manufacturing products from wood or wood fibers in which microwaves are used to preheat a binding agent. Veneered woods are to be manufactured in particular.

The tunnel furnaces known from practice that are used to heat or dry materials such as ceramic, stone, wool, powder, or the like generally have a housing with a square or circular cross section. As a basic principle, the known devices have proven their worth, but they have room for improvement in terms of efficiency. This is where the invention comes in.

### OBJECTS OF THE INVENTION

It is therefore an object of the present invention to provide an improved method and furnace for continuously heating a textile web.

Another object is the provision of such an improved method and furnace for continuously heating a textile web that overcomes the above-given disadvantages, in particular that can heat or preheat a pressed mat in an efficient and economical manner.

A further object is to provide a tunnel furnace that is characterized by a simple design, high efficiency, and optimal preheating of a strip workpiece, particularly a pressed mat.

### SUMMARY OF THE INVENTION

A method of continuously heating a moving strip workpiece. The method has according to the invention the step of passing the strip workpiece in a horizontal travel direction through a tunnel furnace with a tunnel housing of oval cross section, providing the oval cross section of greater horizontal width than vertical height, and irradiating the workpiece with microwave radiation in the tunnel housing. Especially preferably, oval means elliptical or substantially elliptical. The tunnel housing is preferably embodied and/or oriented as an oval such that its width is greater than its height. Here, the width and height of the housing preferably refers to the interior width and interior height and, consequently, to the width and height of the interior space, especially preferably the maximum interior width and maximum interior height, of the oval cross section. Consequently, the width of the oven then preferably extends transverse to the normally horizontal travel direction of the strip workpiece and parallel to the workpiece plane, for example pressed mat, to be preheated, whereas the height of the housing then extends along the direction of thickness of the strip workpiece (or pressed mat) and is normally vertical.

The invention proceeds in this regard from the discovery that, if a strip workpiece passes through an oval or elliptical tunnel furnace, the microwaves can be concentrated optimally on the relevant area and therefore optimally on the area of the strip workpiece to be heated. An especially uniform field distribution occurs in this area, thereby resulting in the uniform heating of the strip workpiece. Moreover, the reflection of waves on the product (back) to the microwave generators is minimized. All in all, the strip workpiece (for example pressed mat) can be heated more efficiently with such an elliptical tunnel furnace than with conventional tunnel furnaces having a round or rectangular cross section. This also has to do with the fact that the microwaves can be radiated into the interior space via a plurality of feedthrough apertures that are in or on the housing, with these feedthrough apertures being distributed over the periphery and/or along the longitudinal direction of the housing. The microwaves therefore do not pass into the furnace via feedthrough apertures that are distributed on a circular path or on a rectangular path; rather, the feedthrough apertures are distributed according to the invention on an oval (for example elliptical) periphery that ensures the described optimized irradiation and improved field distribution.

The object of the invention is also a tunnel furnace for continuously heating a moving strip workpiece according to the described method. Such a tunnel furnace is especially preferably used to preheat a pressed mat during the manufacture of wood-based panels or the like. The tunnel furnace has a plurality of microwave generators for generating microwaves that can radiate into the interior of the housing through feedthrough apertures in or on the housing, with the tunnel housing having an oval cross section according to the invention, preferably an elliptical cross section. The feedthrough apertures for the microwaves into the interior space are distributed over the periphery or along the longitudinal direction of the housing.

For the flawless connecting of the microwaves over the elliptical cross section of the housing, it can be advantageous to fasten the microwave generators (directly) on the housing and to distribute them over the periphery and/or along the longitudinal direction of the housing. The optimal connecting of the microwaves over the oval periphery of the housing then occurs at the same time through the geometric arrangement of the microwave generators. Alternatively, however, it also lies within the scope of the invention for the microwave generators to be not themselves distributed or arranged over an oval or elliptical periphery; rather, the microwave generators can also be arranged in another position on the housing or also next to/below/above the housing, in which case the microwave generators are preferably connected to the housing, more particularly to the feedthrough apertures of the housing, via waveguides. In this case as well, the connecting of the microwaves into the interior of the housing occurs via an oval periphery or cross section. The waveguides are preferably metal tubes having a rectangular cross section, for example. Alternatively, waveguides having a circular or elliptical cross section are also used, in which case the waveguides are dimensioned as a function of the frequency or wavelength of the microwave radiation such that appropriate propagation of the microwaves within the waveguide occurs.

The tunnel housing of the tunnel furnace according to the invention preferably has not only a jacket having an oval cross section, but also a front wall on the upstream intake end and a front wall on the downstream output end that close off the furnace on the inlet and downstream output end. Since the strip workpiece to be heated is to be passed continuously through the tunnel furnace, the front wall on the upstream intake end and/or the front wall on the downstream output end have an intake port on the one hand and an output port on the other end through which the traveling strip workpiece can enter and exit the housing. To prevent or reduce losses in the area of these openings, it is advantageous to connect an intake tunnel extension to the intake port on the one hand and/or an output tunnel extension to the output port on the other hand. Such an intake extension or output extension generally has a substantially smaller cross-sectional size than the housing or the tunnel furnace itself, so that the microwave losses through the intake extension and the output extension are minimized. The intake extension and the output extension are generally structurally designed like waveguides (that is, they can be rectangular tubes, for example) made of an electrically conductive material (for example metal), with these tunnels being dimensioned to fit the width and height of the workpiece such that no or minimal propagation of the microwaves of the specific wavelength occurs, so that they have a “destructive” effect, as it were, in that the oscillation modes of the microwaves are suppressed.

Overall, an improvement of the field distribution to the areas to be heated and hence to the strip workpiece itself is achieved in the context of the invention. Uniform field distribution and, consequently, homogeneous heating occurs in the desired areas, and thus in the strip workpiece, and what is more, the inventive design of the housing results in a reduction in the reflections of waves from the product to the generator.

Microwaves with a frequency from 100 MHZ to 300 GHz, for example 300 GHZ to 100 GHz, can be used according to the invention. Microwaves with a frequency from 500 MHZ to 50 GHz are preferably used.

### BRIEF DESCRIPTION OF THE DRAWING

The above and other objects, features, and advantages will become more readily apparent from the following description, reference being made to the accompanying drawing in which:

FIG. 1 is a small-scale schematic side view of an apparatus for treating and heating an elongated moving strip workpiece according to the invention;

FIG. 2 is a simplified perspective view of the tunnel furnace of FIG. 1; and

FIG. 3 is a schematic vertical cross section through the FIG. 2 furnace.

### SPECIFIC DESCRIPTION OF THE INVENTION

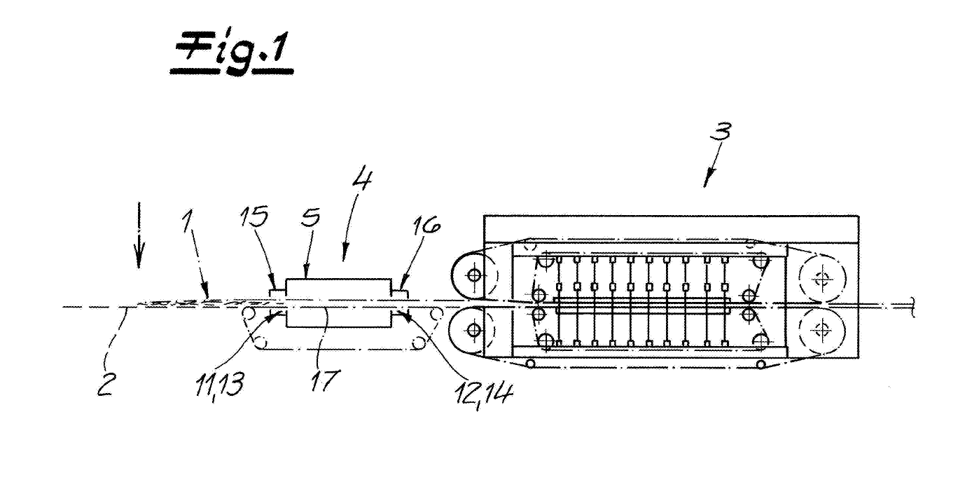

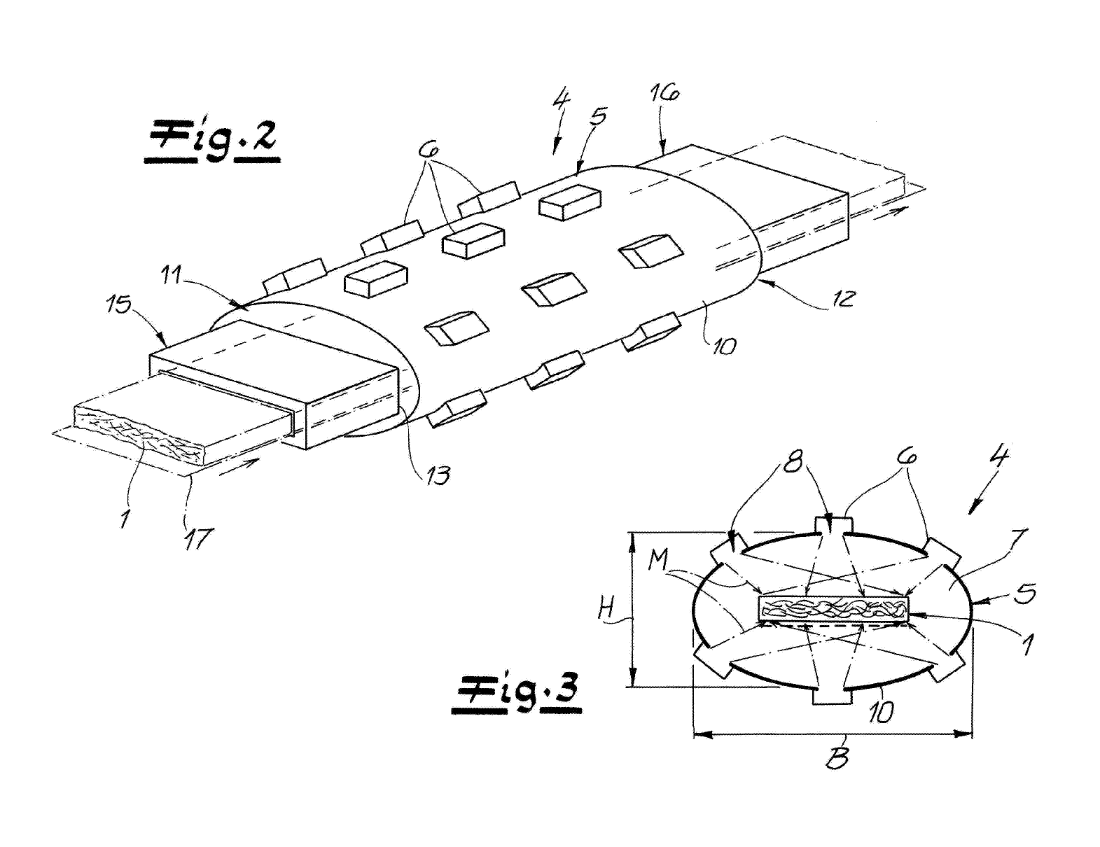

FIG. 1 shows a simplified view of a system for manufacturing wood-based panels in a continuous cycle. First, the loose material to be pressed (consisting of wood fibers or wood shavings, for example) is scattered with the aid of a scattering device onto a belt conveyor 2 to form a scattered material mat 1. The scattered material mat 1 manufactured in this way is pressed into a finished wood-based panel (for example particle or fiber board) in a continuously operating press 3 under application of pressure and heat. Such a press 3 is generally embodied as a dual-belt press having an upper heated platen and a lower heated platen as well as endlessly circulating press belts (for example of steel) in the upper part and lower part of the press, with these press belts being supported on the pressing plates/heated platens with interposition of rolling element assemblies (for example roller bars). At least one of the heated platens is biased by press cylinders that are supported on the press structure (for example on the press frame).

In order to optimize the pressing process within the press 3, the pressed mat 1 is preheated in the context of the invention with the aid of a tunnel furnace 4 shown only schematically in FIG. 1. For the purpose of preheating the strip workpiece 1, the pressed mat 1 thus passes through the tunnel furnace 4 that has a tunnel housing 5. Moreover, the tunnel furnace 4 has a plurality of microwave generators 6 with which microwaves M are generated, so that the strip workpiece 1 is exposed to microwaves in the interior 7 of the housing 5 and thereby heated. The microwave generators 6 can be magnetrons, or the generators can have such magnetrons. According to the invention, the tunnel housing 5 have an oval and preferably elliptical cross section, with the width B of the housing 5 being greater than the height H of the housing. In this illustrated embodiment, the width B and height H refer to the (maximum) width B and the (maximum) height H of the interior 7 of the housing 5.

Through these measures, and thus the oval or elliptical design of the tunnel housing 5, an especially efficient connecting of the microwaves M and improved field distribution in the area to be heated, and consequently within the pressed mat 1, is achieved. This is indicated in FIG. 3. It can be seen that the microwaves M radiate through feedthrough apertures 8 into the interior 7, these feedthrough apertures of the housing being arranged on the oval periphery of the housing 5. A plurality of microwave generators 6 can be distributed over the periphery of the housing. These generators 6 are preferably arranged above and below the mat 1 to be heated, so that the upper and lower sides of the mat are irradiated and thus heated. In addition, a plurality of microwave generators 6 can be distributed over the length of the housing 5.

In the illustrated embodiment, the microwave generators 6 themselves are directly on the housing 5 and thus distributed on the elliptical outer surface so that the described irradiation occurs via the elliptical or oval periphery.

It also lies within the scope of the invention, however, to arrange the microwave generators 5 separately at a spacing from the housing, for instance, beside the housing, under the housing, and/or over the housing, and connect the microwave generators with waveguides to the housing or feedthrough apertures. Even if the microwave generators themselves are not on an oval periphery in such an embodiment, which is not shown in the figures, the coupling of the microwaves does occur nonetheless in the inventive manner via an oval periphery of the housing.

Furthermore, the drawing shows that the housing has a jacket 10 that has the described oval cross section. Moreover, the housing 5 has an intake-end front wall 11 and an output-end back wall 12, with the intake wall 11 having an intake port 13 and the output wall having an output port 14 through which the pressed mat 1 enters and exits the housing 5.

In the illustrated embodiment, in order to prevent or reduce leakage of microwave radiation M from the interior of the housing, an outwardly projecting intake extension 15 is connected to the intake port 13 and an outwardly projecting output extension 16 is connected to the output port 14. For this purpose, the intake and output extension 15 and 16 can be shaped as waveguides, for example as rectangular tubes, but dimensioned such that the corresponding modes of the microwave radiation are suppressed.

The pressed mat 1 passes through the tunnel furnace 4 on a forming belt or conveyor belt 17 that is made of a nonconductive material so that it can pass through the microwave furnace 4 without problems during operation. In principle, it can be the same forming belt onto which the pressed mat is scattered. However, it also lies within the scope of the invention to provide a separate, endlessly circulating forming belt 17 for the tunnel furnace, so that the pressed mat 1 previously scattered onto a first forming belt 2 is subsequently transferred to a second forming belt 17 that passes through the tunnel furnace 4.

I claim:

1. A method of continuously heating a moving strip workpiece, the method comprising the step of:
passing the strip workpiece in a horizontal travel direction through a tunnel furnace with a tunnel housing of oval cross section;
providing the oval cross section of greater horizontal width than vertical height; and
irradiating the workpiece with microwave radiation in the tunnel housing.

2. The method defined in claim 1, wherein the housing has a substantially elliptical cross section.

3. The method defined in claim 1, further comprising the steps of:
radiating the microwave radiation into an interior of the tunnel housing via apertures uniformly distributed around and along in the tunnel housing.

4. The method defined in claim 1, further comprising the step of:
supporting the strip workpiece on a conveyor belt in the tunnel housing.

5. The method defined in claim 1, wherein the strip workpiece is a pressed wood-particle mat.

6. A tunnel furnace for continuously heating a moving strip workpiece, the furnace comprising:
an oval-section tunnel housing having an interior through which the workpiece passes in a horizontal travel direction, the tunnel having a predetermined vertical height and a predetermined horizontal width; and
a plurality of microwave generators on the housing for irradiating the workpiece in the interior of the tunnel with microwave radiation.

7. The tunnel furnace defined in claim 6, wherein the tunnel is formed with a plurality of apertures each aligned with a respective one of the microwave generators, the apertures being distributed uniformly around and along the tunnel housing.

8. The tunnel furnace defined in claim 6, wherein the microwave generators are fixed on an outer surface of the tunnel at the respective apertures.

9. The tunnel furnace defined in claim 6, wherein each of the generators has a respective waveguide fitted to the respective aperture.

10. The tunnel furnace defined in claim 6, wherein the housing has a pair of horizontally spaced end walls each formed with a respective port slot through which the work piece passes.

11. The tunnel furnace defined in claim 6, wherein the tunnel housing is provided with a horizontally outwardly extending tubular extension at at least one of the ports.

12. The tunnel furnace defined in claim 11, wherein there is such an extension at each of the ports.

13. The tunnel furnace defined in claim 12, wherein each of the tunnels and the respective port has a cross section conforming to a cross section of the workpiece and having an inner periphery fitting closely around the workpiece.
